(19) United States
(12) Patent Application Publication
(10) Pub. No.: US 2016/0248248 A1
(43) Pub. Date: Aug. 25, 2016

(54) ELECTRICITY PROVIDING SYSTEM INCLUDING BATTERY ENERGY STORAGE SYSTEM

(71) Applicant: LSIS CO., LTD., Anyang-si (KR)

(72) Inventor: JAE SEONG SHIM, Seoul (KR)

(73) Assignee: LSIS CO., LTD., Anyang-si (KR)

(21) Appl. No.: 14/958,796

(22) Filed: Dec. 3, 2015

(30) Foreign Application Priority Data
Feb. 24, 2015 (KR) 10-2015-0026058

(51) Int. Cl. H02J 1/10; H02J 7/00

(52) U.S. Cl. CPC H02J 1/10; H02J 7/007

(57) ABSTRACT

Disclosed is a power supply system. A power supply system according to an embodiment includes a charging control unit configured to control charging/discharging of a battery energy storage system, and a system control unit configured to receive an electric energy amount output from the battery energy storage system, determine an amount of electric energy to be distributed to each of a plurality of charging control units on the basis of the received electric energy amount and rated outputs of the charging control units, and control the charging control units in parallel on the basis of a result of the determining.

### CROSS-REFERENCE TO RELATED APPLICATIONS

Pursuant to 35 U.S.C. §119(a), this application claims the benefit of earlier filing date and right of priority to Korean Patent Application No. 10-2015-0026058, filed on Feb. 24, 2015, the contents of which are all hereby incorporated by reference herein in its entirety.

### BACKGROUND

The present disclosure relates to provision of an ancillary service for a power system, and particularly, to a method for operating a charging control unit for controlling an output of a battery.

Electric energy is widely used due to the easiness of converting and transmitting the electric energy. A battery power supply system is used in order to efficiently use such electric energy. The battery power supply system receives power so as to be charged. Furthermore, the battery power supply system discharges charged power when power is required. In this manner, the battery power supply system may adaptively supply power.

In detail, in the case where a power generation system includes the battery power supply system, the battery power supply system is operated as below. The battery power supply system discharges stored electric energy when a load or a system is overloaded. In the case where the load or the system is lightly loaded, the battery power supply system receives power from a generator or the system so as to be charged.

In the case where the battery power supply system is independent of the power generation system, the battery power supply system receives idle power from an external power supply so as to be charged. Furthermore, in the case where the system or the load is overloaded, the battery power supply system discharges the charged power to supply power.

A power supply system represents a storage device that stores power excessively generated in a power plant or new renewable energy irregularly generated and transmits power when power is temporarily insufficient.

In detail, the power supply system stores electricity in an electric power system in order to supply energy to a place when energy is required therein. In other words, the power supply system is one assembly including a storage in which a system is integrated with one product like a typical secondary battery.

The power supply system has become an essential device for storing unstable generated energy such as wind power energy which is a type of new renewable energy that has been recently and widely used and for stably supplying the stored energy back to a power system when necessary. If the power supply system is not provided, a serious problem such as sudden power failure may occur in the power system due to unstable power supply dependent on wind or solar light. Therefore, in such an environment, the field of storage is becoming more important and is extending to the field of a domestic power storage system.

Such a power supply system is installed in a generation system, a transmission/distribution system, and a consumer in a power system, and is used for the purpose of frequency regulation, stabilization of an output of a generator using new renewable energy, peak shaving, load leveling, emergency power supply, or the like.

The power supply system is classified into a physical energy storage type and a chemical energy storage type according to a storage type. Pumped-storage power generation, compressed air storage, a flywheel, or the like may be used for the physical energy storage type, and a lithium-ion battery, a lead storage battery, a NaS battery, or the like may be used for the chemical energy storage.

### SUMMARY

Embodiments provide a power supply system in which a system control unit efficiently controls a charging control unit by virtue of an adaptive configuration of the charging control unit.

Embodiments also provide a power supply system in which an output of a battery is controlled for each charging control unit so that the charging control unit is able to be easily replaced.

In one embodiment, a power supply system includes a battery power supply system including: a charging control unit configured to control charging/discharging of a battery energy storage system; and a system control unit configured to receive an electric energy amount output from the battery energy storage system, determine an amount of electric energy to be distributed to each of a plurality of charging control units on the basis of the received electric energy amount and rated outputs of the charging control units, and control the charging control units in parallel on the basis of a result of the determining.

The system control unit may determine the amount of electric energy to be distributed to each charging control unit according to a level of the rated output of each charging control unit.

The system control unit may control only a portion of the charging control units on the basis of the result of the determining.

The system control unit may determine the amount of electric energy to be distributed to each charging control unit in consideration of at least one of information on a time of input to the power supply system, weather information, or remaining battery capacity information together with the rated outputs.

The details of one or more embodiments are set forth in the accompanying drawings and the description below. Other features will be apparent from the description and drawings, and from the claims.

### BRIEF DESCRIPTION OF THE DRAWINGS

FIG. 1 is a block diagram illustrating an overall configuration of a power supply system.

FIG. 2 is a block diagram illustrating a power supply system according to an embodiment.

FIG. 3 is a block diagram illustrating a small-capacity power supply system according to an embodiment.

FIG. 4 is a conceptual diagram illustrating a structure of an electricity market according to an embodiment.

FIGS. 5A and 5B illustrate that a plurality of charging control units are controlled in parallel according to an embodiment.

FIG. 6 is a flowchart illustrating a process of operating a plurality of charging control units in parallel in a power supply system according to an embodiment.

### DETAILED DESCRIPTION OF THE EMBODIMENTS

Hereinafter, embodiments will be described in detail with reference to the accompanying drawings. In the following description, the terms “module” and “unit” for referring to elements are given or used interchangeably in consideration of ease of description, and thus, the terms per se do not necessarily represent different meanings or functions.

The advantages and features of the present invention, and methods for achieving the advantages and features will be apparent from the embodiments described in detail below with reference to the accompanying drawings. The present invention may, however, be embodied in different forms and should not be construed as being limited to the embodiments described below. Rather, these embodiments are provided so that this disclosure will be thorough and complete, and will fully convey the scope of the present invention to those skilled in the art, and the present invention is defined by the scope of claims. Like reference numerals refer to like elements throughout.

Detailed descriptions of well-known functions or configurations will not be provided in order not to unnecessarily obscure the present disclosure. The terms used herein are defined in consideration of the functions of the embodiments, but may be changed depending on the practice or intention of a user or operator. Thus, the definitions should be determined based on the overall content of the present disclosure.

Combinations of the operations of the flowcharts and the blocks in the accompanying drawings may be performed by computer program instructions. Since the computer program instructions may be installed in a processor of a general-purpose computer, a special-purpose computer, or any other programmable data processing equipment, the instructions performed by the processor of a computer or any other programmable data processing equipment generates a means for performing the functions described with respect to the blocks or flowcharts in the accompanying drawings. Since the computer program instructions may also be stored in a computer-usable or computer-readable memory oriented to a computer or any other programmable data processing equipment in order to implement functions in a specific manner, the instructions stored in the computer-usable or computer-readable memory may produce manufacture items involving instruction means for performing the functions described with respect to the blocks or flowcharts in the accompanying drawings. Since the computer program instructions may also be installed in a computer or any other programmable data processing equipment, the instructions which operates the computer or any other programmable data processing equipment by generating computer-executable processes by performing a series of operations in the computer or any other programmable data processing equipment may provide operations for performing the functions described with respect to the blocks or flowcharts in the accompanying drawings.

Furthermore, each block or each operation may represent a part of a code, a segment or a module including one or more executable instructions for performing specific logical function(s). Furthermore, it should be noted that the functions mentioned with respect to the blocks or operations may be performed in arbitrary order. For example, two contiguous blocks or operations illustrated in the drawings may be performed at substantially the same time, or may be performed in reverse order depending on corresponding functions.

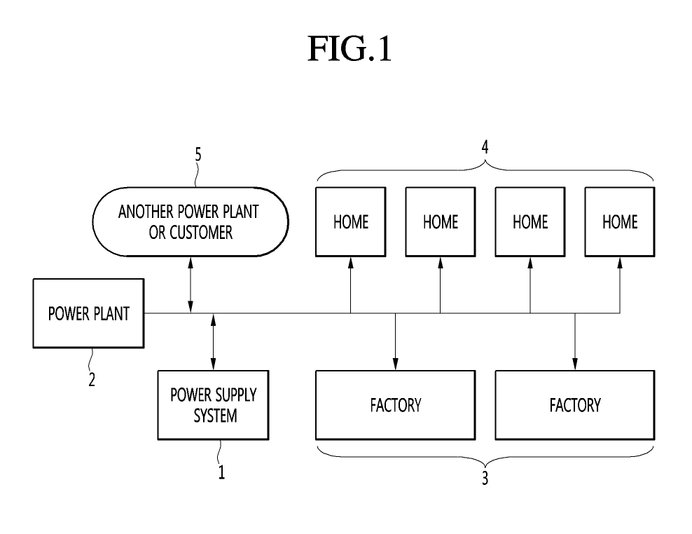

FIG. 1 is a block diagram illustrating an overall configuration of a power supply system. As illustrated in FIG. 1, a power supply system 100 may constitute one platform together with a power plant 2, a factory 3, a home 4, and another power plant or consumer 5.

According to an embodiment, energy generated in the power plant 2 may be stored in the power supply system 100. Furthermore, the energy stored in the power supply system 100 may be transmitted to the factory 3 or the home 4, or may be sold to another power plant or consumer.

Electric energy generated in the power plant 2 greatly varies with an environment or time. For example, in the case of photovoltaic power generation, the amount of power generation may vary with weather conditions or a sunrise time. In such a case, it may be difficult to stably use generated electric energy in the factory 3 or the home 4. To overcome this limitation, the electric energy generated in the power plant may be stored in the power supply system, and the stored electric energy may be stably output so that the energy may be used in the factory 3 or the home 4. Furthermore, remaining electric energy may be sold to the other consumer 5. In addition, in the case where the factory 3 or the home 4 consumes more electric energy than the electric energy stored in the power supply system 100, electric energy may be purchased from the other power plant 5.

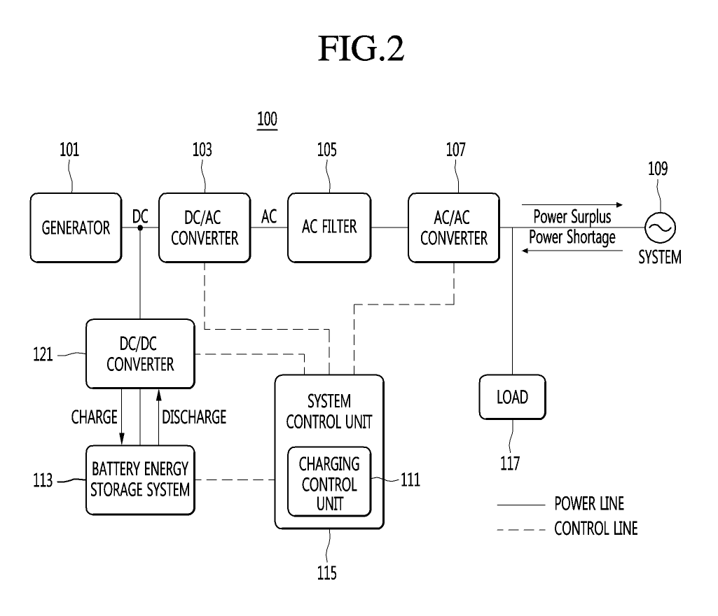

FIG. 2 is a block diagram illustrating a generated power supply system according to an embodiment.

The power supply system 100 according to an embodiment includes a generator 101, a DC/AC converter 103, an AC filter 105, an AC/AC converter 107, a system 109, a charging control unit 111, a battery energy storage system 113, a system control unit 115, a load 117, and a DC/DC converter 121.

The generator 101 generates electric energy. In the case where the generator is a photovoltaic power generator, the generator 101 may be a solar cell array. A plurality of solar cell modules are combined with each other in the solar cell array. The solar cell module is a device in which a plurality of solar cells are connected to each other in series or in parallel to generate a predetermined voltage or current by converting solar energy into electric energy. Accordingly, the solar cell array absorbs solar energy and converts the solar energy into electric energy. In the case where a generation system is a wind power generation system, the generator 101 may be a fan for converting wind power energy into electric energy. However, as described above, the power supply system 100 may supply power only via the battery energy storage system 113 without the generator 101. In this case, the power supply system 100 may not include the generator 101.

The DC/AC converter 103 converts DC power into AC power. The DC/AC converter 103 receives, via the charging control unit 111, DC power supplied by the generator 101 or DC power discharged from the battery energy storage system 113 to convert the received power into AC power.

The AC filter 105 filters noise of the power converted into the AC power. Depending on a specific embodiment, the AC filter 105 may be omitted.

The AC/AC converter 107 converts a level of a voltage of the noise-filtered AC power so as to supply the power to the system 109 or the load 117. Depending on a specific embodiment, the AC/AC converter 107 may be omitted.

The system 109 represents a system in which a number of power plants, substations, transmission/distribution lines, and loads are integrated with each other so that the generation or use of power is performed therein.

The load 117 receives electric energy from the generation system and consumes power. The battery energy storage system 113 receives electric energy from the generator 101 so as to be charged, and discharges the charged electric energy according to power demand-supply conditions of the system 109 or the load 117. In detail, in the case where the system 109 or the load 117 is lightly loaded, the battery energy storage system 113 receives idle power from the generator 101 so as to be charged. In the case where the system 109 or the load 117 is overloaded, the battery energy storage system 113 discharges the charged power to supply power to the system 109 or the load 117. The power demand-supply conditions of the system 109 or the load 117 may greatly vary with a time slot. Therefore, it is inefficient for the power supply system 100 to uniformly supply the power supplied by the generator 101 without considering the power demand-supply conditions of the system 109 or the load 117. Therefore, the power supply system 100 controls the amount of power supply according to the power demand-supply conditions of the system 109 or the load 117, using the battery energy storage system 113. In this manner, the power supply system 100 may efficiently supply power to the system or the load 117.

The DC/DC converter 121 converts a level of DC power supplied or received by the battery energy storage system 113. Depending on a specific embodiment, the DC/DC converter 121 may be omitted.

The system control unit 115 controls operation of the DC/AC converter 103 and the AC/AC converter 107. The system control unit 115 may include the charging control unit 111 for controlling charging or discharging of the battery energy storage system 113. The charging control unit 111 controls charging or discharging of the battery energy storage system 113. In the case where the system 109 or the load 117 is overloaded, the charging control unit 111 receives power from the battery energy storage system 113 to supply the power to the system 109 or the load 117. In the case where the system 109 or the load 117 is lightly loaded, the charging control unit 111 receives power from an external power supply or the generator 101 to transfer the power to the battery energy storage system 113.

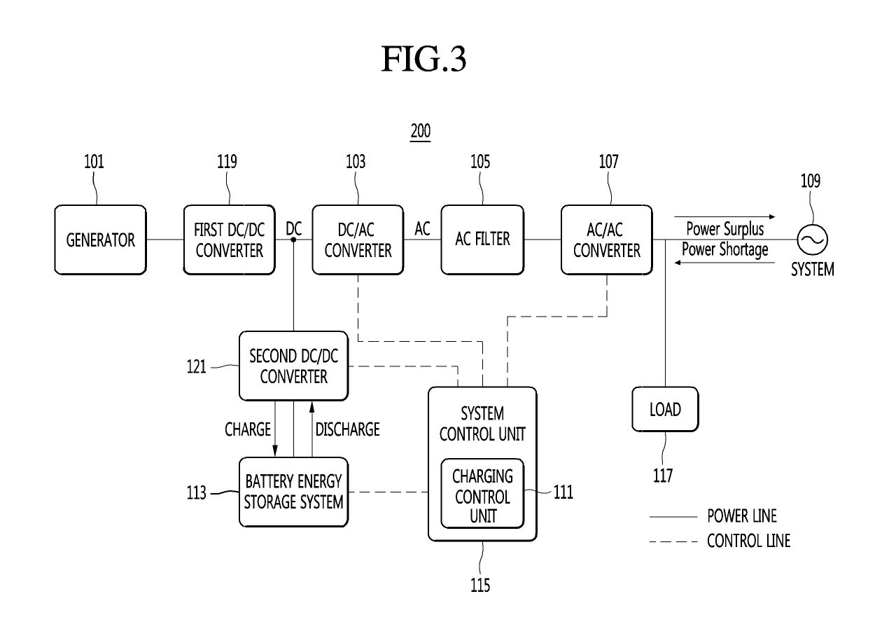

FIG. 3 is a block diagram illustrating a small-capacity power supply system according to an embodiment.

A small-capacity power supply system 200 according to an embodiment includes a generator 101, a DC/AC converter 103, an AC filter 105, an AC/AC converter 107, a system 109, a charging control unit 111, a battery energy storage system 113, a system control unit 115, a first DC/DC converter 119, a load 117, and a second DC/DC converter 121.

Compared to the system of FIG. 2, the system of FIG. 3 further includes the first DC/DC converter 119. The first DC/DC converter 119 converts a voltage of DC power generated by the generator 101. In the small-capacity power supply system 200, the voltage of power generated by the generator 101 is low. Therefore, voltage boosting is required in order to input the power supplied by the generator 101 to a DC/AC converter. The first DC/DC converter 119 converts the voltage of power generated by the generator 101 into a voltage able to be input to the DC/AC converter 103.

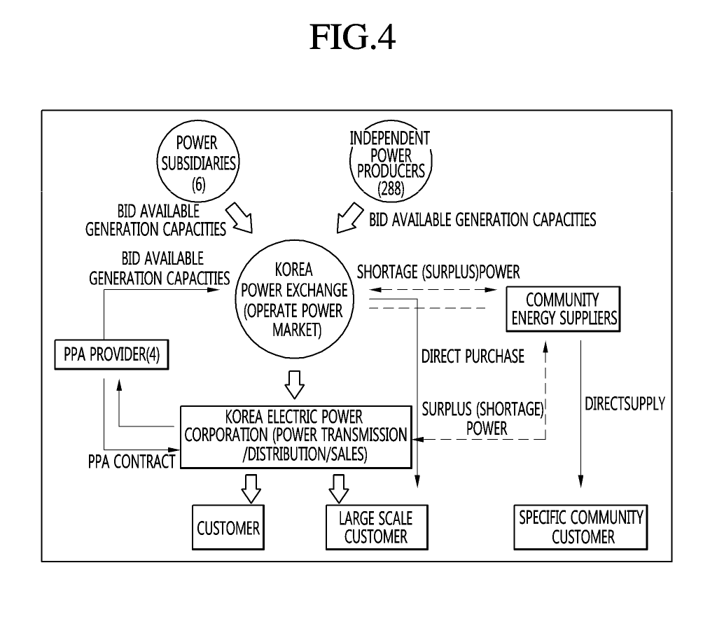

FIG. 4 is a conceptual diagram illustrating a structure of a power market according to an embodiment.

Referring to FIG. 4, the power market includes power subsidiaries, independent power producers, power purchase agreement (PPA) providers, community energy suppliers, Korea Power Exchange, Korea Electric Power Corporation, customer, large scale customers, and specific community customers. As of 2014, domestic power generation companies include six power subsidiaries separated from the Korea Electric Power Corporation and 288 independent power producers.

The power subsidiaries, the independent power producers, the PPA providers, and the community energy suppliers may represent power generation companies, may bid their available generation capacities depending on the amount of power able to be generated by their own generators in the Korea Power Exchange, and may obtain profits from the bid.

Each power subsidiary and each independent power producer bid their available generation capacities of each generator on a daily basis in the Korea Power Exchange, and the Korea Power Exchange operates the power market.

The Korea Electric Power Corporation purchases power at a price determined in the power market, and supplies the purchased power to customers. Accordingly, the Korea Electric Power Corporation takes charge of power transmission, distribution, and sales.

The PPA providers may be contractors of the PPA, and the PPA providers bid their available generation capacities to the power market. The payment for power transaction is settled not by the price determined in the power market but by a PPA contract with the Korea Electric Power Corporation. Furthermore, a resultant settlement rule may be added to settlement rule information of the power market.

The community energy suppliers generate power with certain scale generators, and directly sell the generated power in their licensed areas. Furthermore, the community energy suppliers may directly purchase insufficient power from the Korea Electric Power Corporation or the power market, or may sell surplus power to the Korea Electric Power Corporation or the power market.

The large scale customers of which contract power is at least 30,000 kW may directly purchase desired power from the power market without intervention of the Korea Electric Power Corporation.

The charging control unit 111 for controlling the battery energy storage system 113 may be present in plurality in one power supply system 100. Furthermore, the plurality of charging control units 111 may have different characteristics. For example, the charging control units 111 may have different efficiencies of converting the electric energy stored in the battery energy storage system 113 so that the energy is usable in the factory 4 or the home 3. Furthermore, the charging control units 111 may have different degrees of output of electric energy for most efficiently performing conversion.

Therefore, an embodiment proposes a power supply system in which the charging control units 111 are assigned different ratios of processing electric energy output from the battery energy storage system 113 so that optimal conversion efficiency may be achieved. Furthermore, an embodiment proposes a power supply system in which different electric energy conversion ratios are respectively assigned to the charging control units 111 so that, even if some of the charging control units 111 are faulty, the faulty charging control units 111 may be simply replaced.

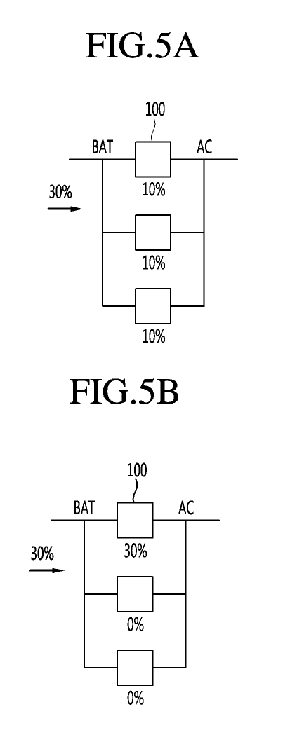

FIGS. 5A and 5B illustrate that the charging control units 111 according to an embodiment are controlled in parallel.

As illustrated in FIG. 5A, in general, each charging control unit 111 performs electric energy conversion in the same ratio, while the power supply system 100 operates the charging control units 111 via the system control unit 115. In this case, control logic may be easily designed, but different characteristics of the charging control units 111 are not considered. Furthermore, as the charging control units 111 constantly perform electric energy conversion, it is difficult to handle a situation in which a portion of the charging control units 111 is faulty. For example, provided that about 30% of the electric energy stored in the battery energy storage system 113 is output, three charging control units 111 conventionally convert the output electric energy in the same ratio.

However, a second charging control unit and a third charging control unit may exhibit highest efficiency when converting 30% of an entire storage capacity, whereas a first charging control unit exhibits highest efficiency when converting 10% of the storage capacity. Here, an electric energy output amount at which highest conversion efficiency is exhibited may be referred to as a rated output.

In this case, since the second and third charging control units perform conversion at an interval at which low conversion efficiency is exhibited, the operation of the charging control units may be inefficient parallel operation in terms of an entire power supply system.

Therefore, in an embodiment, as illustrated in FIG. 5B, the charging control units 111 are controlled so that the charging control units 111 perform electric energy conversion in different ratios. In a specific embodiment, when the system control unit 115 controls the charging control units 111, the system control unit 115 may adjust a conversion ratio according to characteristics of each charging control unit 111. For example, in the case where highest efficiency is exhibited when the first charging control unit converts about 30% of entire stored electric energy, the system control unit 115 allocates all the 30% electric energy output from the battery energy storage system 113 to the first charging control unit. Electric energy may not be allocated to the second and third charging control units.

As a result, the charging control units 111 are controlled so as to perform conversion most efficiently, according to the amount of electric energy output from the battery energy storage system 113, thereby maximizing the efficiency of the entire power supply system. Furthermore, since some of the charging control units 111 may be unused, the lives of the unused charging control units 111 may be increased. Moreover, in the case where a portion of the charging control units 111 is faulty, since electric energy conversion is performed only by the non-faulty charging control units 111, the faulty charging control unit 111 may be easily replaced.

In an embodiment, the power supply system 100 may control parallel operation of the charging control units 111 for each time slot. For example, the power supply system 100 may include a first charging control unit 111 having a high rated output and a second charging control unit 111 having a low rated output. In the daytime, it may be efficient to operate the charging control unit 111 having a high rated output since an electric energy consumption amount is large. At night, it may be efficient to operate the charging control unit 111 having a low rated output since the electric energy consumption amount is relatively small.

In relation to this operation, the power supply system 100 may store an electric energy use amount of one day according to accumulated data, and may determine which of the charging control units 111 should be operated. In detail, the power supply system 100 may operate, via the system control unit 115, the first charging control unit 111 alone in the daytime and may operate the second charging control unit 111 alone at night.

In another embodiment, the power supply system 100 may in parallel operate the charging control units 111 according to weather information. For example, since the electric energy consumption amount is large on a hot day or a cold day, it may be efficient to operate the charging control unit 111 having a high rated output. Accordingly, the power supply system 100 may control, via the system control unit 115, the parallel operation of the charging control units 111 according to prestored or updated weather information.

In another embodiment, the power supply system 100 may control, via the system control unit 115, the charging control units 111 according to the amount of the electric energy stored in the battery energy storage system 113.

For example, in the case where the system control unit 115 determines that the amount of electric energy remaining in the battery energy storage system 113 is small, the system control unit 115 may control the charging control units 111 so that only the charging control unit 111 having a low rated output is operated. For another example, in the case where the system control unit 115 determines that the amount of electric energy remaining in the battery energy storage system 113 is large, the system control unit 115 may control the charging control units 111 so that only the charging control unit 111 having a high rated output is operated.

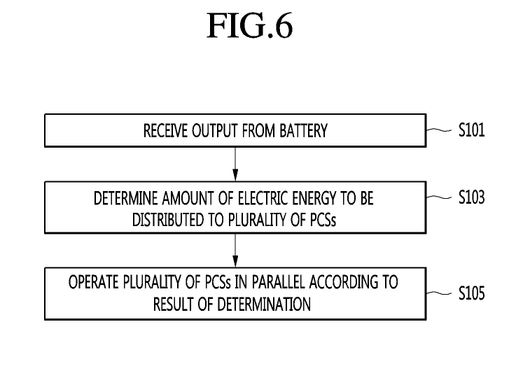

FIG. 6 is a flowchart illustrating a process of operating the charging control units 111 in parallel in the power supply system 100 according to an embodiment.

The system control unit 115 receives an electric energy output from the battery energy storage system 113 (S101).

The system control unit 115 determines an amount of electric energy to be distributed to the charging control units 111 on the basis of an amount of the received output (S103). In detail, the system control unit 115 may have data on a rated output of the charging control units 111 currently included in the power supply system. The data on a rated output may be stored at the time of initial design, and may be newly stored when the charging control unit 111 is replaced. Therefore, the system control unit 115 compares the stored data on a rated output with the electric energy output amount to determine the amount of electric energy to be converted by the charging control units 111.

In detail, the system control unit 115 determines an output of the battery energy storage system 113 to be distributed to the charging control units 111 so that it is closest to a rated output of each charging control unit 111. Furthermore, the system control unit 115 determines the output of the battery energy storage system 113 to be distributed to the charging control units 111 in consideration of a rated output value together with at least one of a current time, weather conditions, or a remaining capacity of the battery energy storage system 113.

Therefore, the system control unit 115 may allocate, to the charging control units 111, different amounts of electric energy to be converted, and an allocation amount may be determined according to a level of the rated output of each charging control unit 111.

The system control unit 115 controls the parallel operation of the charging control units 111 on the basis of a result of the determination. In detail, the system control unit 115 may control a degree of electric energy conversion to be performed by each charging control unit 111. In a specific embodiment, only a portion of the charging control units 111 may be operated, or all the charging control units 111 may be operated to perform different electric energy conversions.

According to an embodiment, in the power supply system, the system control unit may efficiently control the charging control unit by virtue of an adaptive configuration of the charging control unit.

Furthermore, according to an embodiment, in the power supply system, an output of a battery is controlled for each charging control unit so that the charging control unit is able to be easily replaced.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for controlling a power supply system comprising a battery power supply system, the method comprising:
receiving an electric energy amount output from a battery energy storage system;
determining an amount of electric energy to be distributed to each of a plurality of charging control units on the basis of the received electric energy amount and rated outputs of the charging control units; and
controlling the charging control units in parallel on the basis of a result of the determining,
wherein the determining the amount of electric energy to be distributed comprises determining the amount of electric energy to be distributed in consideration of at least one of information on a time of input to the power supply system, weather information, or remaining battery capacity information together with the rated outputs.

2. The method according to claim 1, wherein the amount of electric energy to be distributed to each charging control unit is determined according to a level of the rated output of each charging control unit.

3. The method according to claim 2, wherein the controlling the charging control units in parallel comprises controlling only a portion of the charging control units on the basis of the result of the determining.

4. A power supply system comprising a battery power supply system comprising:
a charging control unit configured to control charging/discharging of a battery energy storage system; and
a system control unit configured to receive an electric energy amount output from the battery energy storage system, determine an amount of electric energy to be distributed to each of a plurality of charging control units on the basis of the received electric energy amount and rated outputs of the charging control units, and control the charging control units in parallel on the basis of a result of the determining.

5. The power supply system according to claim 4, wherein the system control unit determines the amount of electric energy to be distributed to each charging control unit according to a level of the rated output of each charging control unit.

6. The power supply system according to claim 5, wherein the system control unit controls only a portion of the charging control units on the basis of the result of the determining.

7. The power supply system according to claim 4, wherein the system control unit determines the amount of electric energy to be distributed to each charging control unit in consideration of at least one of information on a time of input to the power supply system, weather information, or remaining battery capacity information together with the rated outputs.
